(19) United States
(12) Patent Application Publication
(10) Pub. No.: US 2022/0015377 A1
(43) Pub. Date: Jan. 20, 2022

(54) Perforated Wall Mold

(71) Applicant: SEB S.A., Ecully (FR)

(72) Inventors: Emmanuelle Caregnato, Bloye (FR); Nicolas Nys, Chavanod (FR); Stéphane Plichon, Allonzier La Caille (FR)

(73) Assignee: SEB S.A., Ecully (FR)

(21) Appl. No.: 17/279,657

(22) PCT Filed: Sep. 20, 2019
(86) PCT No.: PCT/EP2019/075377

§ 371 Date: Mar. 25, 2021

(30) Foreign Application Priority Data
Sep. 25, 2018 (FR) 1858757

(51) Int. Cl. A21B 3/13

(52) U.S. Cl. CPC A21B 3/13

(57) ABSTRACT

The invention relates to a mold for cooking food, in particular for baking pastries, comprising at least one cavity for receiving the food to be cooked, said receiving cavity comprising an opening and an upper edge connected to an upper wall of the mold. According to the invention, the upper wall comprises a plurality of openings arranged at the periphery of the upper edge.

### TECHNICAL FIELD

The present invention relates to the field of molds for food use and more particularly to molds for baking pastries.

### STATE OF THE ART

Patent FR2852491 B1 describes a mold for cooking food, in particular for baking pastries, comprising a series of cavities for receiving the food to be baked, geometrically arranged in parallel rows, each cavity comprising an opening and an upper edge connected to an upper wall of the mold. In this document, the upper wall of the mold is equipped with an array of air circulation holes in a staggered arrangement relative to the receiving cavities.

Such a mold has the advantage of enhancing the circulation of hot air, which tends to move upwards through the air circulation holes to allow good ventilation of the mold and rapid baking.

However, such a configuration of the mold's air circulation holes does not make it possible to obtain a well-crisped upper surface on the food after baking, particularly around the rim of this upper surface. For example, if the user wishes to obtain a well-crisped rim around the upper surface of a cake by increasing either the baking temperature or the baking time, the rim of the upper surface of the cake is often overcooked or even burned while the cake is not fully cooked or even raw in the middle.

Moreover, such a mold presents the drawback of having an arrangement of air circulation holes that leads to unevenly-cooked food depending on the various positions of the receiving cavities. During baking, the receiving cavities around the periphery of the mold do not get the same amount of hot air as the ones in the middle of the mold. Thus, after baking, the results vary between the food to be baked that is situated around the periphery of the mold and the food to be baked that is situated in the middle of the mold.

### SUMMARY OF THE INVENTION

The purpose of the present invention is to propose a pastry mold that remedies the aforementioned drawbacks and, in particular, that allows the food to bake evenly irrespective of the position of the receiving cavity on the mold. Another purpose of this invention is to enhance non-enzymatic browning around the rim of the upper surface of the food during baking, either by caramelization when the food to be baked is rich in sugar or due to the Maillard reaction.

Another purpose of the invention is to propose a mold with a design that is simple and economical to use.

To this end, the invention relates to a mold for cooking food, in particular for baking pastries, comprising at least one cavity to receive the food to be baked, said receiving cavity comprising an opening and an upper edge connected to an upper wall of the mold, the upper wall comprising a plurality of holes arranged around the periphery of upper edge.

The presence of the holes enhances convective heat transfer at the periphery of the upper edge. The mold thus produced has the advantage of enhancing the hot air circulation as close as possible to the upper edge of each receiving cavity in order to improve the crispness of the upper surface of the food and also to obtain a well-crisped rim around this upper surface. For example, a cake with a well-crisped rim around the edge of the upper surface is better-tasting and also has a delicious and appealing appearance.

The mold according to the invention has the advantage of enabling the food to be baked correctly with improved crispness on the upper surface, without needing to adjust the baking time and/or temperature, and ensuring that the center of the food remains moist after baking. In addition, this arrangement of the holes in a shape similar to the opening of the receiving cavity makes it possible to obtain a well-crisped rim around the upper surface of the food, irrespective of the shape of the opening of the receiving cavity.

By “well-crisped on one surface of the food after baking” it should be understood that an outer part of the food to be baked firms up while baking and is browned at the end of the baking time. The outer part is crunchy.

Advantageously, the mold according to the present invention makes it possible to make bread, brioche, cannoli, savory or sweet cakes, muffins and other pastries that are well-crisped. According to another characteristic of the invention, the ratio between the total surface area of the holes around the upper edge of the receiving cavity and the surface area of the opening of this same receiving cavity is comprised from 0.01 to 0.3, preferably from 0.1 to 0.3.

The minimum value of the surface ratio reinforces the uniformity of the baking on the upper surface of the food after baking, while the maximum value of the surface ratio improves the crispness of the upper surface and of the rim of this upper surface while preventing the latter from becoming too hard at the end of the baking time.

According to another characteristic of the invention, the number of holes arranged around the upper edge of the receiving cavity is greater than or equal to 5, preferably greater than or equal to 10, and particularly preferably greater than or equal to 15.

Such a feature allows a minimum amount of hot air to flow through the holes in order to optimize the circulation around the mold and its manageability.

According to another characteristic of the invention, each of the holes is identical to the others in shape, substantially oblong or elliptical.

Such a feature makes it possible to maximize the air flow while keeping a minimum amount of material between two adjacent holes in order to preserve the rigidity of the entire mold.

According to another characteristic of the invention, each of the holes is identical to the others in shape, substantially circular.

Such a feature makes it possible to optimize the air flow when there is no need for the entire mold to be highly rigid.

Advantageously, each hole has a longitudinal dimension comprised from 3 to 5 mm, and a transverse dimension comprised from 1 to 2 mm.

Such a feature makes it possible to maximize the air flow while keeping a minimum amount of material between two adjacent holes in order to preserve the rigidity of the entire mold and its ease of handling.

According to another characteristic of the invention, each hole comprises a longitudinal axis that crosses the upper edge at one point, the tangent at the upper edge at this point being perpendicular to the longitudinal axis.

Such a feature makes it possible to arrange a maximum number of holes around the upper edge to achieve good crispness on the upper surface of the food after baking.

According to another characteristic of the invention, the holes at the periphery of the upper edge are arranged in a star formation around the upper edge; the longitudinal axes of the holes forming the rays of a star converge towards the center or centers of the geometric shape formed by the upper edge. Thus, the longitudinal axes of the holes are arranged in the shape of a radius that traces straight lines from a center of the geometric shape formed by the upper edge.

According to another characteristic of the invention, the holes at the periphery of the upper edge are concentrically arranged relative to the upper edge. Thus, the holes at the periphery of the upper edge are arranged so as to form a crown around the upper edge.

According to another characteristic of the invention, the holes at the periphery of the upper edge are arranged such that the shortest distance between each hole and the upper edge is less than or equal to 10 mm, preferably less than or equal to 5 mm.

Such a feature has the advantage of directing the hot air towards the upper edge of the receiving cavity, making it possible to effectively improve the crispness of the rim around the upper surface of the food after baking.

Advantageously, the shortest distance between each hole and the upper edge is invariable. Such a feature makes it possible to obtain a uniformly well-crisped rim around the upper surface of the food after baking.

Advantageously, the holes are evenly arranged around the receiving cavity. Such a feature makes it possible to obtain a uniformly-crisped rim around the upper surface of the food after baking.

According to another characteristic of the invention, the mold comprises an accessory that can be moved between an open position in which the holes are open and a closed position in which the holes are plugged.

Such a feature makes the mold versatile. Users can close or open the holes according to their needs in order to control the level of crispness of the upper surface of their cakes.

Advantageously, the mold is flexible.

According to one variant of the invention, the mold is silicone-based.

Thus, such a flexible mold, for example silicone-based, presents the advantage of being flexible, heat-resistant, non-stick and easy to clean. A silicone-based mold also facilitates the use of the present invention.

### BRIEF DESCRIPTION OF THE DRAWINGS

The following is a description of specific embodiments of the present invention, provided by way of example and not limited thereto. It will help us to better understand the purposes, aspects and advantages of this invention, in conjunction with the drawings in the annex, wherein:

FIG. 1 is a perspective view of a mold according to a first particular embodiment of the invention;

FIG. 2 is a top view of the mold in FIG. 1;

FIG. 3 is a cross-sectional view of the mold along the III-III cut line in FIG. 2;

FIG. 4 is a view of the underside of FIG. 1;

FIG. 5 is a detailed view of the holes at the periphery of the upper edge of FIG. 2;

FIG. 6 is a perspective view of a mold according to a second particular embodiment of the invention;

FIGS. 7 and 8 are perspective and top views, respectively, according to a third particular embodiment of the invention;

FIGS. 9 and 10 are perspective and top views, respectively, according to a fourth particular embodiment of the invention;

FIGS. 11 and 12 are perspective and top views, respectively, according to a fifth particular embodiment of the invention;

FIG. 13 is a top view of a sixth particular embodiment of the invention.

### DETAILED DESCRIPTION

Only the elements required to understand the invention have been depicted. In order to facilitate interpretation of the drawings, the same elements are labeled with the same references across all figures.

It should be noted that in this document, the terms “horizontal”, “vertical”, “upper”, “lower”, “front” and “rear” used to describe the mold refer to this mold when it is placed flat on its receiving cavity.

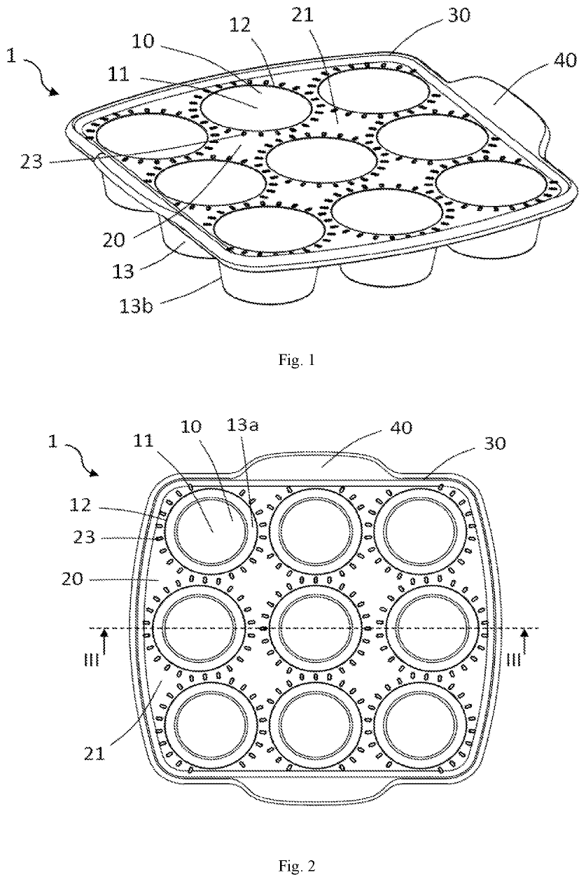

FIG. 1 illustrates a flexible mold 1 which is intended for baking pastries in an oven (not illustrated), for making bread, brioche, savory or sweet cakes, muffins, etc. The flexible mold 1 comprises a plurality of receiving cavities 10 of identical dimensions distributed geographically in parallel rows on an upper wall 20 of the mold 1. The receiving cavities 10 are intended to receive food to be baked (food preparation).

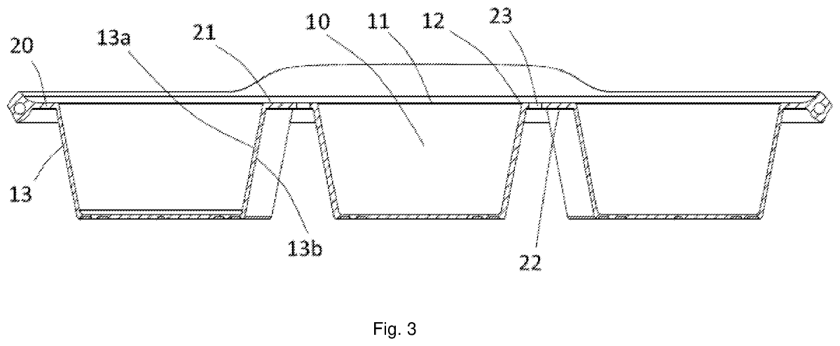

Each receiving cavity 10 has an opening 11 through which the food to be baked is poured prior to baking and from which the baked food (cakes or pastries) is extracted after baking. The opening 11 of the receiving cavity 10 is delimited by an upper edge 12, which is connected to a first side 21 of the upper wall 20. Each receiving cavity 10 comprises a receiving wall 13 that extends from the upper edge 12 and protrudes onto a second side 22 of the upper wall 20, opposite the first side 21 and visible in FIG. 3.

In reference to FIG. 3, the receiving wall 13 comprises an inner side 13a which is in contact with the food to be baked during baking, and an outer side 13b which is opposite the inner side 13a and is exposed to a means of heating (not illustrated). For example, the means of heating is the heating element in the oven that emits heat during baking.

The mold 1 is preferentially made of silicone material which is flexible, resistant to high cooking temperatures, non-stick and easy to clean.

As shown in FIG. 1, the mold 1 comprises a rigid frame 30 delimiting the upper wall 20. The mold 1 comprises two handles 40 arranged opposite each other. The handles 40 originate from the frame 30 and extend outside the mold 1.

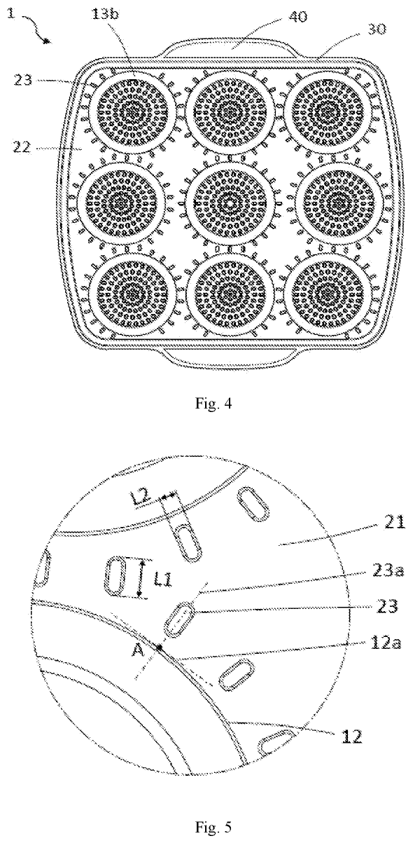

As illustrated in FIGS. 1 to 4, the mold 1 comprises a plurality of holes 23 that are arranged on the upper wall 20. The holes 23 are set perpendicular to the upper wall 20. The holes 23 are evenly arranged at the periphery of the upper edge 12 of each receiving cavity 10. The arrangement of the holes 23 around the receiving cavity 10 and the arrangement of the upper edge 12 of this receiving cavity 10 are concentric and have a similar shape. As can be seen in FIG. 2, the upper edge 12 is circular. The holes 23, which are concentrically arranged at the periphery of the upper edge 12, are circular in shape.

As illustrated in FIG. 5, each hole 23 has a substantially oblong shape. Advantageously, each hole 23 has a longitudinal dimension L1 comprised from 3 to 5 mm, and preferentially comprised from 3 to 4 mm, and a transverse dimension L2 comprised from 1 to 2 mm, and preferentially comprised from 1 to 1.5 mm. The hole 23 comprises a semicircle at each of its two longitudinal ends. The flow-through surface of each hole 23 is preferentially greater than 4 mm².

The number of holes 23 arranged at the periphery of the upper edge 12 of each receiving cavity 10 is greater than or equal to 5, preferably greater than or equal to 10, and particularly preferably greater than or equal to 15. The surface ratio between the total surface area of the holes 23 at the periphery of the upper edge 12 of each receiving cavity 10 and the surface area of the opening 11 of the receiving cavity 10 is comprised from 0.01 to 0.3, preferably from 0.1 to 0.3.

As can be seen in FIG. 5, each oblong hole 23 has a longitudinal axis 23a which crosses the upper edge 12 at a point A, the tangent 12a at the upper edge 12 at this point A being perpendicular to the longitudinal axis 23a. The arrangement of the holes 23 thus made makes it possible to arrange a maximum amount of holes 23 around the upper edge 12 while preserving sufficient rigidity of the entire mold to ensure its ease of handling.

The holes 23 are arranged such that the shortest distance D between each hole 23 and the upper edge 12 is less than or equal to 10 mm, preferably less than or equal to 5 mm. Advantageously, the receiving cavity 10 is located equidistant from the holes 23 which are arranged at the periphery of the upper edge 12 of this receiving cavity 10.

Baking pastries in mold 1 according to the invention will now be described. First, the user mixes the ingredients according to a pastry recipe in a kitchen utensil to prepare the food to be baked. The food to be baked is in a more or less viscous liquid form. This is usually a raw dough. The user gradually pours the food to be baked into the receiving cavities 10 of the mold 1 via the openings 11. Then, the user turns the oven on and the heating element in the oven is set to reach a setpoint temperature inside the oven. The user places mold 1 containing the food to be baked on a grill inside the oven when the setpoint temperature is reached. Thus, the food in the mold 1 is baked at the setpoint temperature for a set time according to the pastry recipe.

During the baking, the heating element in the oven transfers an amount of heat to the mold 1 to bake the food. The oven generally has a fan to generate a forced-convection heat transfer so that the heat is evenly distributed in the oven. The food solidifies as it bakes until the desired pastries are obtained with a well-crisped crust.

The presence of the holes 23 at the periphery of the upper edge 12 of each receiving cavity 10 further enhances the heat transfer by forced convection around the upper edge 12. A flow of hot air moves through the holes 23 and increases the heat around the upper edge 12 to improve the crispness of the upper surface of the pastries, particularly around the rim of this upper surface of the pastries.

The mold 1 according to the invention presents the advantage of obtaining a well-crisped rim around the upper surface of the food after baking, without needing to adjust the baking time and/or temperature, while ensuring that the food remains moist in the middle after baking. Good crispiness of the outer part of the food is measured using a texturometer or penetrometer that measures the effort required for a piercing tip to penetrate the outer part of the food. If it is crispy, the penetration effort required to penetrate it will be greater than the effort required to penetrate the inside of the food.

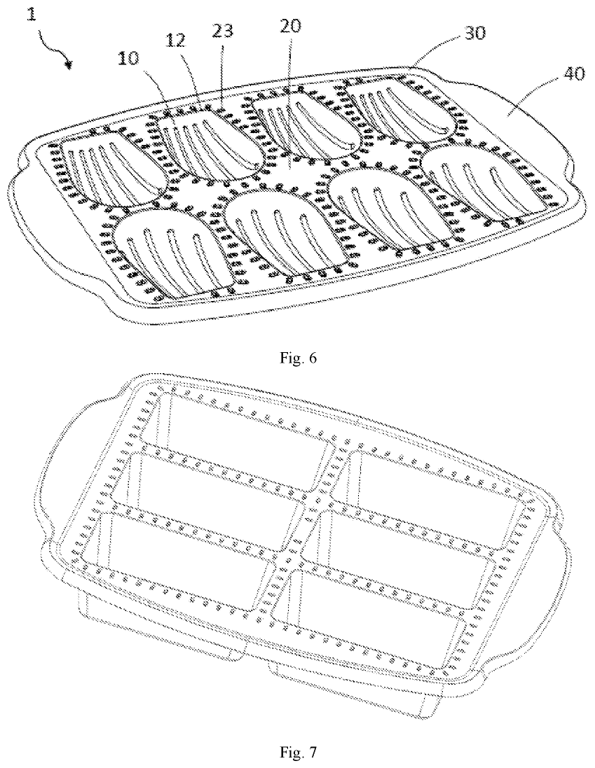

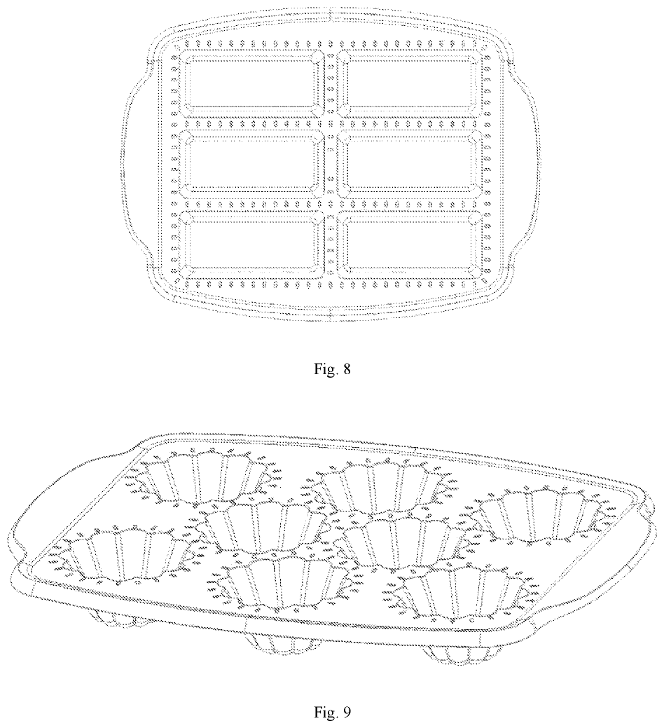

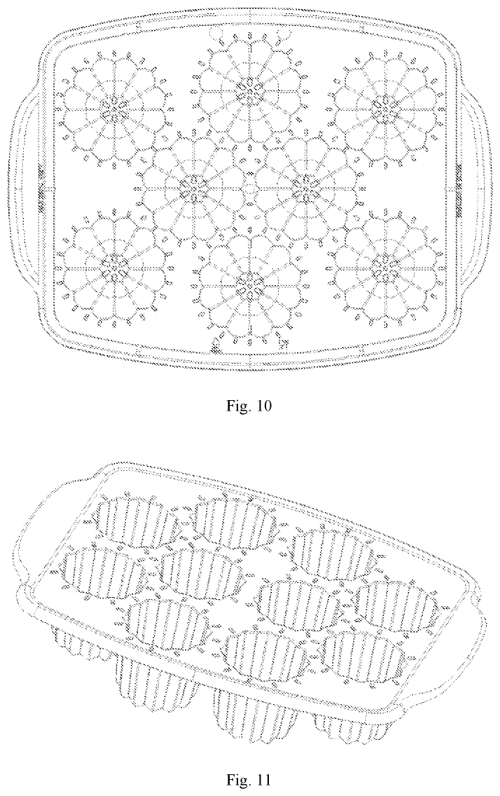

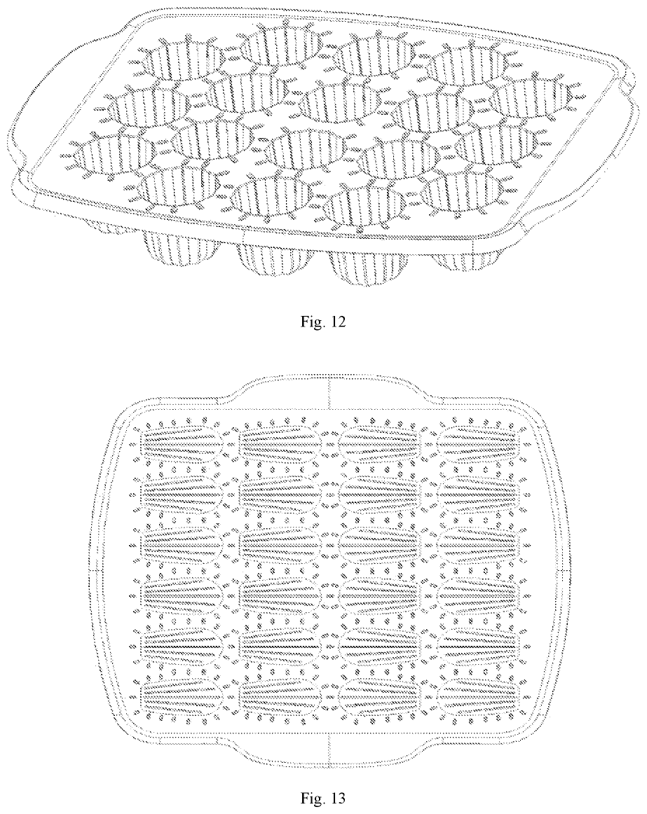

FIG. 6 illustrates a second particular embodiment of the invention in which the flexible mold 1 comprises eight receiving cavities 10 for making madeleines. The upper wall 20 of this mold 1 has holes 23 at the periphery of the upper edge 12 of each receiving cavity 10.

Of course, the invention is in no way limited to the embodiments previously described and illustrated, which have only been provided by way of example. It is still possible to make amendments, specifically with regard to how the various elements are composed or by substituting equivalent techniques, provided that they remain within the scope of the invention.

Thus, in an alternate embodiment of the invention, not shown, the mold comprises receiving cavities of different dimensions to obtain different forms of pastries in the same mold. Thus, in another alternate embodiment of the invention, not shown, the holes can be plugged by a removable stopper. Users can use this stopper to close or open the holes according to their needs in order to control the level of crispness of the upper surface of their cakes.

Thus, in another alternate embodiment of the invention, not shown, the holes are set at an angle comprised between 30 degrees and 90 degrees relative to a horizontal plane that is parallel to the receiving wall.

1. A mold for cooking food, comprising:
at least one cavity for receiving the food to be cooked, said receiving cavity comprising an opening and an upper edge connected to an upper wall of the mold, the upper wall comprising a plurality of holes arranged at the periphery of the upper edge, wherein each hole comprises a longitudinal axis that crosses the upper edge at a point A, a tangent to the upper edge at the point A being perpendicular to the longitudinal axis (23a).

2. The mold according to claim 1, wherein the ratio between the total surface area of the holes at the periphery of the upper edge and the surface area of the opening of the receiving cavity is from 0.01 to 0.3.

3. The mold according to claim 1, wherein the number of holes arranged at the periphery of the upper edge of the receiving cavity is greater than or equal to 5.

4. The mold according to claim 1, wherein each of the holes is identical to the others in shape, substantially oblong or elliptical.

5. The mold according to claim 1, characterized in that the holes at the periphery of the upper edge are arranged in a star formation around the upper edge; the longitudinal axes of the holes forming the rays of a star converge towards the center or centers of the geometric shape formed by the upper edge.

6. The mold according to claim 4, wherein each hole has a longitudinal dimension from 3 to 5 mm and a transverse dimension from 1 to 2 mm.

7. (canceled)

8. The mold according to any of the previous claims, wherein the holes at the periphery of the upper edge are arranged such that the shortest distance between each hole and the upper edge is less than or equal to 10 mm.

9. The mold according to claim 7, wherein the shortest distance between each hole and the upper edge is invariable.

10. The mold according to claim 1, wherein the holes are evenly distributed around the receiving cavity.

11. The mold according to claim 1, further comprising an accessory configured to be moved between an open position in which the holes are open and a closed position in which the holes are plugged.

12. The mold according to claim 1, wherein the mold is a flexible mold.

13. The mold according to claim 1, wherein the mold is silicone-based.
